(19) United States
(12) Patent Application Publication
(10) Pub. No.: US 2003/0065562 A1
(43) Pub. Date: Apr. 3, 2003

(54) Merchandising method and merchandising device

(75) Inventors: Kazuki Matsui, Kawasaki (JP); Masatomo Yasaki, Kawasaki (JP); Satoru Watanabe, Kawasaki (JP); Toshiaki Gomi, Kawasaki (JP)

Correspondence Address: STAAS & HALSEY LLP, 700 11TH STREET, NW, SUITE 500, WASHINGTON, DC, 20001, US

(73) Assignee: Fujitsu Limited, Kawasaki (JP)

(21) Appl. No.: 10/020,248

(22) Filed: Dec. 18, 2001

(30) Foreign Application Priority Data
Sep. 28, 2001 (JP) 2001-300193

(51) Int. Cl. G06F 17/60

(52) U.S. Cl. 705/14

(57) ABSTRACT

In on-line shopping in which ASPs are employed, merchandising method and device designed for promotion of product sales by sharing user use logs between product providers while protecting the users' privacy. If a user U1 has registered a CD for example in a shopping cart, merchandise relevant to the CD, e.g., tickets to a concert to be performed by the same artist, is suggested to the user. User U1's user ID is converted into an anonymous ID for an anonymous user A1. Merchandise name “CD” is converted into merchandise information associated with CDs, e.g., artist name or merchandise name “concert tickets.” This converted data is provided to a concert-ticket provider.

### BACKGROUND OF THE INVENTION

1. Technical Field

The present invention relates to technology for merchandising on networks. It especially relates to marketing promotion technology for on-line shopping in which ASPs (Application Service Providers) are used.

2. Description of Related Art

Electronic commerce using the Internet to do shopping, make travel reservations, etc., has come to be thriving in recent years. Instances where goods/service providers (‘product providers’ hereinafter) use ASPs to avoid the large start-up costs of investing in network-related devices and software development are many. “ASPs” are services that lend out programs to product providers at businesses, or are computers that provide programs, for executing functions, e.g., those known as shopping-cart functions and pay-account functions, needed for on-line services.

If an ASP that, for example, provides a shopping cart program is utilized, user shopping carts are created for user IDs each identifying a user. Use logs containing information concerning products users are interested in, user purchasing histories, etc. are saved in each user's shopping cart. Product providers may acquire information among the purchasing histories saved in the shopping carts concerning products that they themselves provide. Users may refer to the use logs saved in their shopping carts by going through user-ID and password based authentication.

Web sites that ASP administrators run will at times present shopping-cart use logs—in a form stripped of information that would specify individuals—as rankings of products that are selling, and rankings on popular stores. This data is, both for users and for product providers, useful information in learning market developments. Nevertheless, with mere ranking information, as far as product providers are concerned, only general market trends may be grasped, and it is hard to increase direct sales based on that information. In order to promote efficient marketing, merchandise and services customized for each user could be offered by analyzing users' tastes and preferences from basic user information such as age, sex, occupation, hobbies, and from the aforementioned use logs, which would be a more effective merchandising means.

When a user who is a fan of classical music for example purchases, or registers in a shopping cart for, a music CD by an artist he or she likes, one way of merchandising might be to have sales information on new CDs or information on concerts by that artist sent to the user. Moreover, information on other compositions composed by the composer of music selections performed by that artist might be provided to the user. Because appealing information would be sent to the user in this case, the probability of the user purchasing CDs or making ticket reservations based on this information would be high, which would expectedly tie in with sales increases. For the user too, interesting information would be acquired quite effectively.

It would be difficult for a single product provider to do all of these, but it would be possible for various product providers, e.g., CD shops where CDs are sold, and ticket shops where sales of and reservations for concert tickets are made, to provide information relevant to users' needs.

Nevertheless, for various product providers to make offers of merchandise and services that suit user tastes and preferences requires a setup by which basic user information and use logs that one product provider has on hand is provided to other product providers. Prior to provision, however, users' permission must be obtained, due to the necessity of protecting user privacy. Moreover, even given that users' permission is obtained, if utilizing the same user ID a use log at one product provider is provided to another product provider, the other product provider is liable to apprehend the transactional situation between the user and the product provider.

Furthermore, situations in which basic user information and use logs are employed in forms that are of interest to each product provider are many; and at times these data from one product provider are furnished to another product provider to no avail, while accepting unnecessary data increases administrative burdens. Suppose for example that CD number, price, artist name, song names and copyright ID are contained in merchandise information on a music CD. A CD store would be able to identify that CD based on the CD number, but a ticket shop having received the CD number could not tell to which among its merchandise the number relates. By knowing, for example, the artist name and song name, ticket shops would know to which concert tickets the CD relates. Accordingly, if basic user information and use logs that one product provider has on hand are to be shared with another product provider, the data has to be reworked to suit it to the other product provider's goods and services.

### SUMMARY OF THE INVENTION

An object of the present invention is in providing technology that, by sharing between product providers information regarding users while protecting the users' privacy, serves to promote marketing of products on networks.

The invention in one embodiment is a marketing method for promoting to users on a network sales of product groups including a first product group that a first provider provides and a second product group that a second provider provides. The marketing method includes: a product-storage step of storing product information including first product information relating to the first products included in the first product group, and second product information relating to the second products included in the second product group; a product-selection acceptance step of accepting selection of a product in which a user takes an interest; an intention storage step if the user has selected any first product, of assigning a correspondence between and storing the first product information relating to the first product, and a first user identifier by which the first provider identifies the user; a product reworking step, based on the first product information relating to the first product and the second product information, of reworking the first product information relating to the first product, into second product information relating to any second product having relevancy to the first product; and a first provision step of providing the second product information on the second product, obtained in the product reworking step, to the user identified with the first user identifier.

By this marketing method, if a first product that appeals to a user has been selected, second product information regarding a second product associated with the first product is provided to the user. The likelihood being high that the user is interested in the second product serves to promote marketing. Herein the product-selection acceptance step specifically is a step in which the registration of products through a shopping cart or a wish list is accepted. Further, the product storage step is a step in which the registered products are for each user stored as the contents of the user's shopping cart or wish list. To facilitate illustration, in the following explanation will be made taking a shopping cart as an example.

By this method, the first product information on a first product in which a user is interested is provided as-is to the second provider, except that the first user identifier is made anonymous by conversion into the second user identifier and provided to the second provider, the user's anonymity with respect to the second provider is ensured. The second provider may work on sales promotion by selecting second product information from among products that it deals in itself, which is associated with the first product information.

In another aspect, the present invention is the foregoing marketing method, further including a second provision step of providing to the second provider the second product information obtained in said product reworking step, and the first user identifier.

Information beneficial to the second provider in spreading sales is provided in this way to the second provider. Based on the obtained information the second provider may offer to users products suited to the users' interests.

The invention in a further aspect is the marketing method as set forth above, further including: a first user-reworking step of reworking the first user identifier into a second user identifier by which the second provider identifies the user. In this case, the second provision step provides the second user identifier to the second provider instead of the first user identifier.

In this way the first user identifier by which the first provider identifies a user is converted into a second user identifier by which the second provider identifies the user, and the second user identifier is provided to the second provider. Accordingly, second product information may be provided under circumstances in which users are anonymized with respect to the second provider.

In a still further aspect, the invention is the marketing method as just set forth, wherein the intention storing step, if the user has selected the second product based on the second product information provided in the first provision step, assigns a correspondence between and further stores second product information relating to the second product, and the second user identifier.

In this way, if a user has selected the suggested second product, the second product information and the second user identifier are stored. Thus, users may select the suggested product under anonymity, with respect to the second provider, owing to the second user identifier.

In another aspect, the marketing method is as set forth earlier, but further including: a purchase acceptance step of accepting from the user, based on the first user identifier, an instruction to purchase the second product, originating from the second product information provided in the first provision step; and a settlement process step of carrying out a payment process for the second product, utilizing the second user identifier corresponding to the first user identifier.

Acceptance of, and a payment process for, purchase of the second product are carried out in this way based on the second user identifier. Accordingly, purchase acceptance and the payment process take place under conditions in which users' anonymity is preserved with respect to the second provider.

The present invention in another aspect is the marketing method as set forth immediately above, wherein: the product groups further include a third product group that a third provider provides; the product storage step further stores third product information relating to the third products included in the third product group; and if in the purchase acceptance step an instruction to purchase the second product has been accepted, the product reworking step, based on the second product information relating to the second product and the third product information, reworks the second product information relating to the second product, into third product information relating to any third product having relevancy to the second product.

In this way, if a user has registered in the shopping cart the second product, offered by the second provider, third product information on a third product relevant to the second product is further provided to the user. Products highly likely to hold appeal for users may be offered concatenately, which further serves in marketing.

In another aspect of the invention, the marketing method as set forth immediately above further includes a third provision step of providing to the third provider the third product information obtained in the product reworking step, and the first user identifier.

In this way, third product information is provided to the third provider, who deals in the third products that are offered. By obtaining third product information relevant to a second product for which a user has instructed purchase, the third provider may offer to the user third products that go along with the user's interests.

In a still further aspect, the marketing method as set forth earlier further includes a second user-reworking step of reworking the first user identifier into a third user identifier by which the third provider identifies the user. In this case, the third provision step provides the third user identifier to the third provider instead of the first user identifier.

In this way the first user identifier by which the first provider identifies the user is converted into a third user identifier by which the third provider identifies the user, and the third user identifier is provided to the third provider. Accordingly, third product information may be provided under circumstances in which users are anonymized with respect to the third provider.

In yet another aspect of the invention, the marketing method as set forth in an aspect described above further includes an alteration step of accepting, according to a request from the second provider, a change in the second product information provided to the user in the first provision step.

In this way, the second provider may in addition provide to users alterations in the second product information obtained in the second provision step.

The present invention in an even further aspect is marketing method as initially described above, further including: a request-acceptance step of accepting a request for provision of the first product information stored, in an assigned correspondence with the first user identifier, in the intention-storage step; an iterative execution step of iteratively executing the first provision step whenever there is a the request; and a termination step of ending the iterative execution step.

In this way, second product information is provided iteratively to users for each user request for provision of product information, but in predetermined instances, provision of the second product information is terminated. For example, there will be instances where a fixed time interval has elapsed since second product information was provided to users, instances where users purchase a second product and finish making payment, and instances in which users have refused provision of second product information. In such instances, terminating provision of second product information prevents the provision to users of information not effective in promoting sales from continuing.

In another aspect, the marketing method as set forth earlier further includes a provider-selection acceptance step of accepting from the user selection of a provider in which the user takes an interest. In this case, in the product reworking step, first product information relating to the first product is reworked into second product information for second products that the selected provider handles among any second products having relevancy to the first product.

In this way, users may receive second product offers from their favorite second providers.

The marketing method in again another aspect is as set forth above, and furthermore wherein: the intention storage step further stores, in correlation with the first product information and the first user identifier, user information relating to the user; and the second provision step further provides the user information to the second provider.

“User information” herein is basic information on the user, such as sex, full name, age, and home address. Not only second product information and first user identifier, but also basic user information are provided to the second provider. In this case, the second provider may analyze users' inclinations based on the basic user information, which further serves in marketing.

In a still further aspect, the invention is the marketing method as just set forth, but further including: a disclosure-level setting step of setting a disclosure level at which the user information is provided to the second provider in the second provision step; and a user information reworking step of reworking according to the disclosure level the user information provided to the second provider.

In this way, user information is not passed just the way it is to the second provider, the user information is delivered based on the disclosure level. For example: disclose to designate full name only, or disclose to designate sex only, or disclose to designate age only, or disclose to designate residential area only. This accordingly prevents indiscriminate disclosure of basic user information, which protects privacy.

The present invention in another embodiment is a marketing method for promoting on a network sales of product groups including a first product group that a first provider provides and a second product group that a second provider provides. The marketing method includes: a product-storage step of storing product information including first product information relating to the first products included in the first product group, and second product information relating to the second products included in the second product group; a product-selection acceptance step of accepting selection of a product in which a user takes an interest; an intention storage step if the user has selected any first product, of assigning a correspondence between and storing the first product information relating to the selected first product, and a first user identifier identifying the user; a first user-reworking step of reworking the first user identifier into a second user identifier by which the second provider identifies the user; and a second provision step of providing to the second provider the first product information relating to the first product, and the second user identifier.

The invention in this embodiment demonstrates the same actions and effects as the embodiment initially set forth above.

In a further embodiment the invention is a marketing device for promoting on a network sales of product groups including a first product group that a first provider provides and a second product group that a second provider provides. Here the marketing device includes: product storage means for storing product information including first product information relating to the first products included in the first product group, and second product information relating to the second products included in the second product group; product-selection acceptance means for accepting selection of a product in which a user takes an interest; intention storage means for, if the user has selected any first product, assigning a correspondence between and storing the first product information relating to the selected first product, and a first user identifier identifying the user; product reworking means, based on the first product information relating to the first product and the second product information, for reworking the first product information relating to the first product, into second product information relating to any second product having relevancy to the first product; and first provision means for providing the second product information, obtained by the product reworking means, to the user identified with the first user identifier.

In a still further embodiment, the present invention is computer product for making a computer function as a marketing device for promoting on a network sales of product groups including a first product group that a first provider provides and a second product group that a second provider provides. The computer product is for making the computer function as: product storage means for storing product information including first product information relating to the first products included in the first product group, and second product information relating to the second products included in the second product group; product-selection acceptance means for accepting selection of a product in which a user takes an interest; intention storage means for, if the user has selected any first product, assigning a correspondence between and storing the first product information relating to the selected first product, and a first user identifier identifying the user; product reworking means, based on the first product information relating to the first product and the second product information, for reworking the first product information relating to the first product, into that second product information which relates to any second product having relevancy to the first product; and first provision means for providing the second product information, obtained by the product reworking means, to the user identified with the first user identifier.

The embodiment of the present invention as just set forth, provides a computer product that makes a computer function as each of the means of the embodiment of the invention set forth just before.

The present invention in an even further embodiment is a computer-readable recording medium on which is recorded a marketing program for promoting to users on a network sales of product groups including a first product group that a first provider provides and a second product group that a second provider provides. The computer-readable recording medium on which the marketing program is recorded is thus for executing: a product-storage step of storing product information including first product information relating to the first products included in the first product group, and second product information relating to the second products included in the second product group; a product-selection acceptance step of accepting selection of a product in which a user takes an interest; an intention storage step if the user has selected any first product, of assigning a correspondence between and storing the first product information relating to the first product, and a first user identifier by which the first provider identifies the user; a product reworking step, based on the first product information relating to the first product and the second product information, of reworking the first product information relating to the first product, into second product information relating to any second product having relevancy to the first product; and a first provision step of providing the second product information on the second product, obtained in the product reworking step, to the user identified with the first user identifier.

As recording media herein, flexible disks, hard disks, semiconductor memory, CD-ROMs, DVDs, magneto-optical disks (MOs) and others that a computer can read may be cited.

In another embodiment, the present invention is a user-operated computer comprising: a network-connection means for communicatively connecting the computer to a network, wherein the computer is connected to the marketing device as set forth above for promoting on a network sales of a product group including first products that a first provider provides and second products that a second provider provides; a receiving means for receiving from the marketing device second product information relating to second products relevant to first products in which the user takes an interest; and offering means for outputting, as information relating to suggested products, the second product information received from the receiving means.

The present embodiment is applicable to computers operated by users aforementioned in the embodiment of the invention first set forth above.

In one further embodiment, for promoting on a network sales of a product group including first products that a first provider provides and second products that a second provider provides, the present invention is an information acquisition device that the second provider uses, comprising: a network-connection means for communicatively connecting the information acquisition device to a network, wherein the information acquisition device is connected to a computer for executing the marketing method set forth in the first-noted aspect of the embodiment initially set forth above; an acquisition means for acquiring from the computer a first-user identifier for designating a first user taking an interest in a the first product, and second product information relating to a the second product having relevancy to the first product; and output means for outputting the first-user identifier that the acquisition means has acquired, and the second product information.

A device having to do with the present embodiment corresponds to a computer operated by the second provider providing the second product in the embodiment of the invention first set forth above.

From the following detailed description in conjunction with the accompanying drawings, the foregoing and other objects, features, aspects and advantages of the present invention will become readily apparent to those skilled in the art.

### BRIEF DESCRIPTION OF THE DRAWINGS

FIG. 1 is a conceptual diagram of a merchandising system having to do with a first embodied example of the present invention;

FIG. 2 is a configurational diagram of a merchandising system having to do with the first embodied example;

FIG. 3 is a functional block diagram of an intermediary server in the FIG. 2 system;

FIGS. 4A and 4B are conceptual explanatory diagrams of information stored in a product DB 201;

FIG. 5 is a conceptual explanatory diagram of information stored in a product attribute DB 202;

FIG. 6 is a conceptual explanatory diagram of information stored in a product provider DB 203;

FIG. 7 is a conceptual explanatory diagram of information stored in a customer DB 204;

FIGS. 8A, 8B and 8C are explanatory diagram illustrating composition of users' profile data, which is stored in the FIG. 7 customer profile table 2041;

FIGS. 9A and 9B are explanatory diagrams illustrating composition of profile data for anonymous users (anonymous user A1) in the FIG. 7 customer profile table 2041;

FIG. 10 explanatory diagram illustrating composition of profile data for anonymous users (anonymous user A2) in the FIG. 7 customer profile table 2041;

FIGS. 11A, 11B and 11C are display examples of shopping carts and suggested products on the users' terminals;

FIG. 12 is a display examples of shopping carts and suggested products on the product providers' terminals;

FIG. 13 is a flowchart illustrating flow of a suggested-product information-preparation routine;

FIG. 14 is a flowchart illustrating flow of a cart-updating routine; and

FIG. 15 is a flowchart illustrating flow of the housekeeping routine.

### DETAILED DESCRIPTION OF THE PREFERRED EMBODIMENTS

Overview of Invention

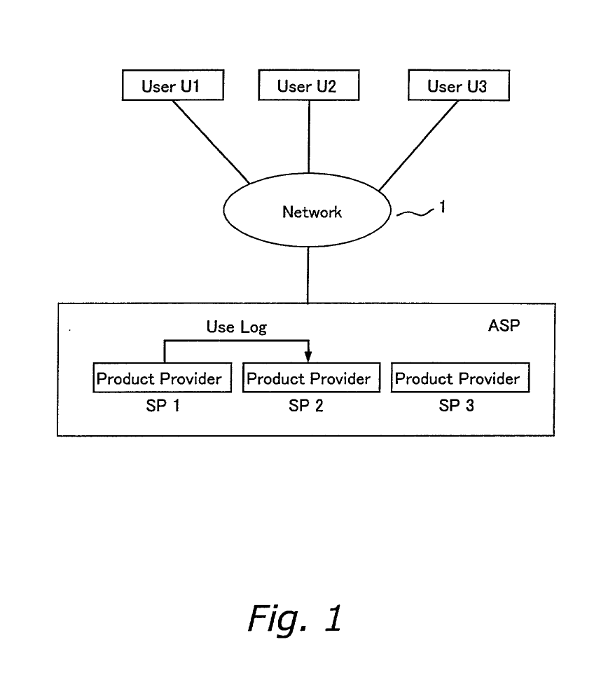

FIG. 1 is a conceptual configurational diagram of a merchandising system having to do with the present invention. In this system an ASP and terminals for users U1, U2, U3 are connected by a network 1. The network 1 is communications channels such as the Internet, a public telephone network or a wireless communications network. The ASP (Application Service Provider) is what a service that provides, or a computer that provides, programs such as shopping cart applications over the network 1 is called. To facilitate explanation, in the embodied example below a case in which the ASP provides a shopping cart application will be taken as an example.

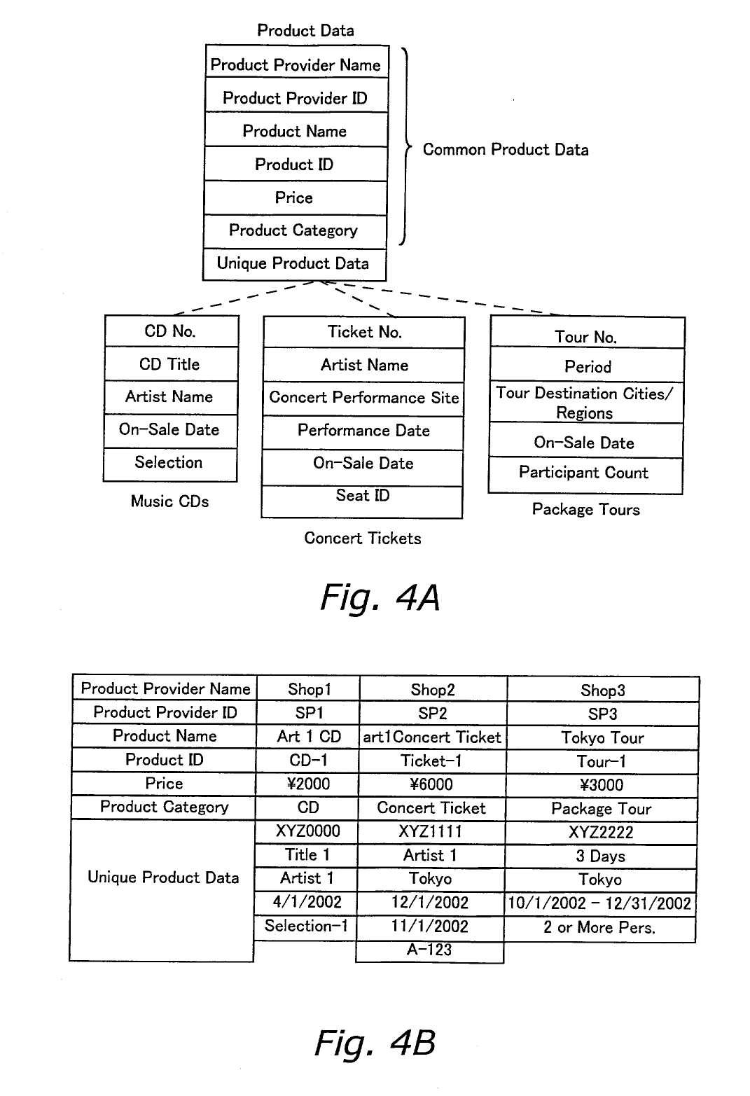

The shopping cart application provides a service that presents a virtual shopping cart to a user. Through this service, product providers SP1, SP2, SP3 provide products at respective electronic shops SHOP 1, SHOP 2, SHOP 3 (indicated in FIG. 4B) on the network 1. Users visit the electronic shops and may put products in their own shopping carts displayed on their terminal screens, and may purchase the inserted products by pushing a purchasing button. Information regarding products registered in a shopping cart and a purchasing history therefrom, i.e., a shopping cart use log, is saved for each user. The product providers SP1, SP2, SP3 consult information among the use logs regarding products that they themselves provide. The products included not only tangibles such as printed matter, music CDs, and concert tickets, but also intangibles such as package tours, i.e., services.

Through the present merchandising system, the ASP notifies the users of products relevant to products in which users have interest. Specifically, in connection with a first product from product provider SP1 that a user has put into a shopping cart, the ASP suggests a second product to the user, together with the contents of the shopping cart. Furthermore, the ASP provides use logs for users U1-U3, who have an interest in the given first product, to product provider SP2 providing the given second product, while protecting the privacy of users U1-U3. Further still, the ASP reworks information on products contained in the use logs into information that product provider SP2 readily uses, and provides it to product provider SP2. Product provider SP2 thereby may work at merchandising by suggesting to users U1-U3 products in which the users seem to be interested.

First Embodied Example

Configuration

(1) Overall Configuration

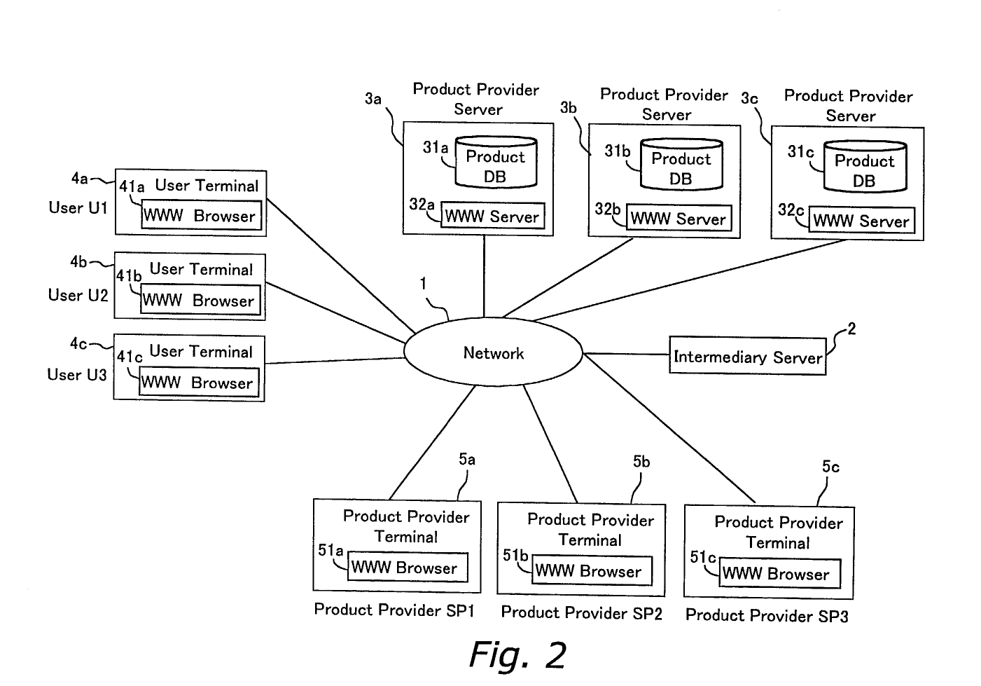

FIG. 2 is a configurational outline view of a merchandising system having to do with the present embodied example. The merchandising system is constituted by connecting through the network 1 an intermediary server 2 as the ASP, product provider servers 3a-3c, user terminals 4a-4c, and product provider terminals 5a-5c.

The intermediary server 2 provides to a user terminal 4a-4c that has accessed any of the product provider servers 3a-3c information relating to shopping-cart content and suggested products, and accepts product registrations and purchase instructions. “Suggested products” herein are not products registered in a shopping cart, but products relevant to the products registered in a shopping cart.

Product provider servers 3a-3c have respectively similar functions, and therefore product provider server 3a will be explained herein. Product provider server 3a is furnished with product DB 31a and WWW server 32. Product information regarding products that product provider SP1 provides in electronic shops is stored in product DB 31a. WWW sever 32 provides to user terminals 4a-4c Web sites for electronic shops that product provider SP1 runs. On these electronic-shop Web sites, respective product information stored in the product DB 31a is displayed.

User terminals 4a-4c have respectively similar functions, and therefore user terminal 4a will be explained herein. User terminal 4a is furnished with WWW browser 41a. WWW browser 41a accesses product provider servers 3a-3c, acquires electronic-shop Web pages, and displays them on the user terminals. WWW browser 41a also acquires from the intermediary server 2, and displays, products registered in a shopping cart and suggested products. Users U1-U3 make various kinds of input on screens displayed by WWW browsers 41a-41c. Input registering products into shopping carts and instructing purchases, is made for example, as are user IDs and passwords for identifying users, and basic user information. “Basic information” refers to information such as users' e-mail addresses, full names, sex, birth dates, home addresses and telephone numbers.

Product provider terminals 5a-5c have respectively similar functions, and therefore product provider terminal 5a will be explained herein. Product provider 5a is furnished with WWW browser 51a. WWW browser 51a accesses product provider server 3a, and acquires and displays product-provider screens for recording products into and deleting them from product DB 31a. WWW browser 51a also accesses the intermediary server 2, and acquires and displays shopping-cart use logs and basic user information. Product providers SP1-SP3 make various kinds of input on screens displayed by the WWW browsers 51a-51c. For example, instructions to change the content of product information stored in product DB 31a, and instructions to change data stored in the intermediary server 2 are accepted.

(2) Intermediary Server Configuration

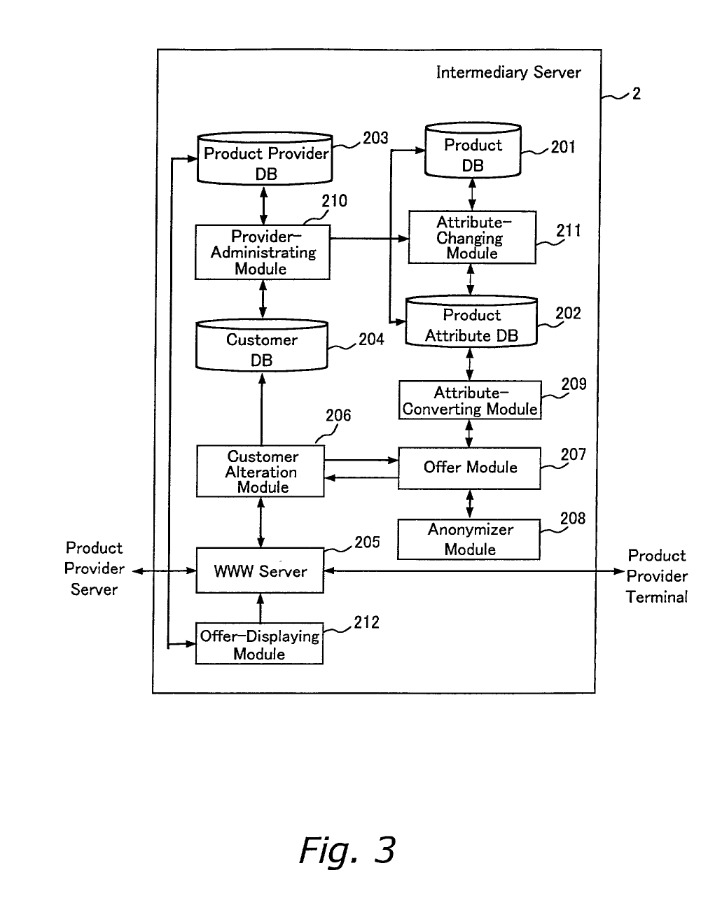

FIG. 3 is a block diagram indicating the functional configuration of the intermediary server 2. The intermediary server 2 is principally furnished with four databases: a product database (DB) 201, a product attribute DB 202, a product provider DB 203, and a customer DB 204. The intermediary server 2 is also furnished with programs for the WWW server 205, customer alteration module 206, offer module 207, anonymizer module 208, attribute-converting module 209, provider-administrating module 210, attribute-changing module 211, and offer-displaying module 212.

(2-1) Databases

First, the databases that the intermediary server 2 has will be explained. FIG. 4A is a conceptual explanatory diagram of information stored in the product DB 201. Information relating to products, i.e., product data, is stored in the product DB 201. Product data is made up of common product data and unique product data. Common product data is data recorded for all products, and includes product provider name, product provider ID, product name, product ID, price, and product category. Unique product data is data indicating attributes of each product, and differs from product to product. In the case of music CDs for example, CD number, CD title, artist name, on-sale date, and selection titles are unique product data. Again, in the case of concert tickets, unique product data items include ticket number, artist name, locale, performance date, on-sale date, and seat IDs.

FIG. 4B is a specific example of product data. For example, the common product data for “Art 1 CD” that product provider SP1 provides is product ID “CD-1,” price “¥2,000,” and product category “CD.” Further, the unique product data for this product is user ID “XYZ0000,” CD title “Title 1,” artist name “Artist 1,” on-sale date “Apr. 4, 2002,” and selection name “Program-1.”

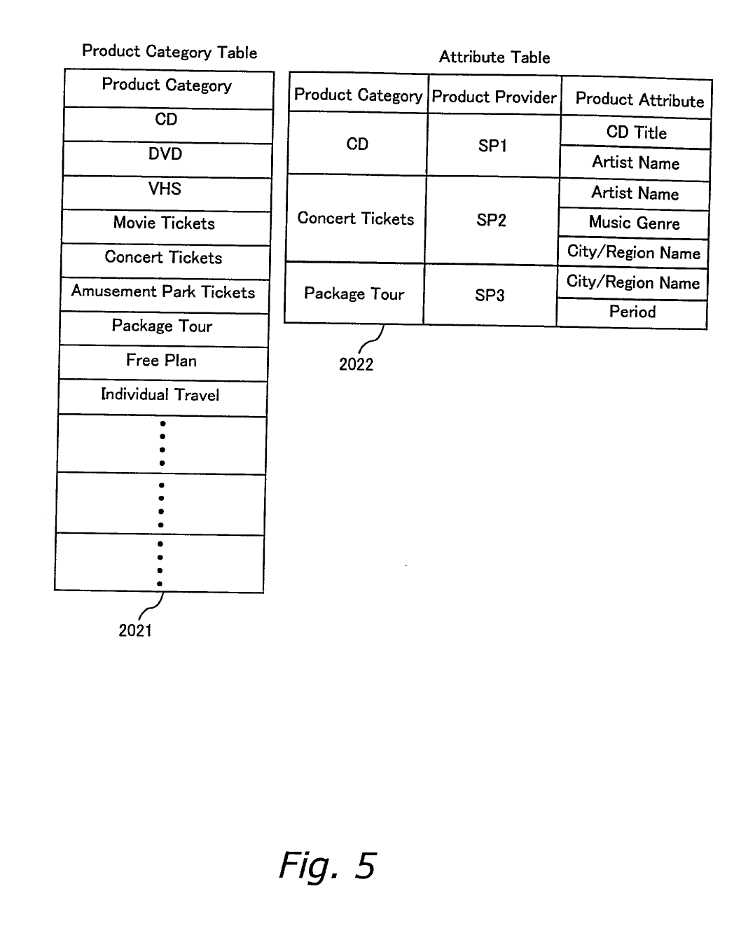

FIG. 5 is a conceptual explanatory diagram of information stored in the product attribute DB 202. The product attribute DB 202 has a product category table 2021 and an attribute table 2022. Product categories are recorded in the product category table 2021. Product category, product provider providing the product in each product category, and product attribute with respect to each product category are recorded in the attribute table 2022. “Attributes” herein is information for mutually correlating the products. A product attribute(s) is one or a number of items selected from the unique product data stored in the product DB 201. Product categories having common product attributes are deemed to be mutually correlated. For example, because the product attribute “artist name” is common between product categories “CD” and “concert tickets,” they are mutually correlated. Accordingly, if “CD” is registered in a shopping cart, “concert tickets” may be offered as a suggested product. By increasing or decreasing the number of attributes corresponding to the product categories, the range of mutually correlated products may be increased or decreased. Setting of the product attributes based on each of the product categories may be carried out for each of the product providers, or may be set regardless of the product provider.

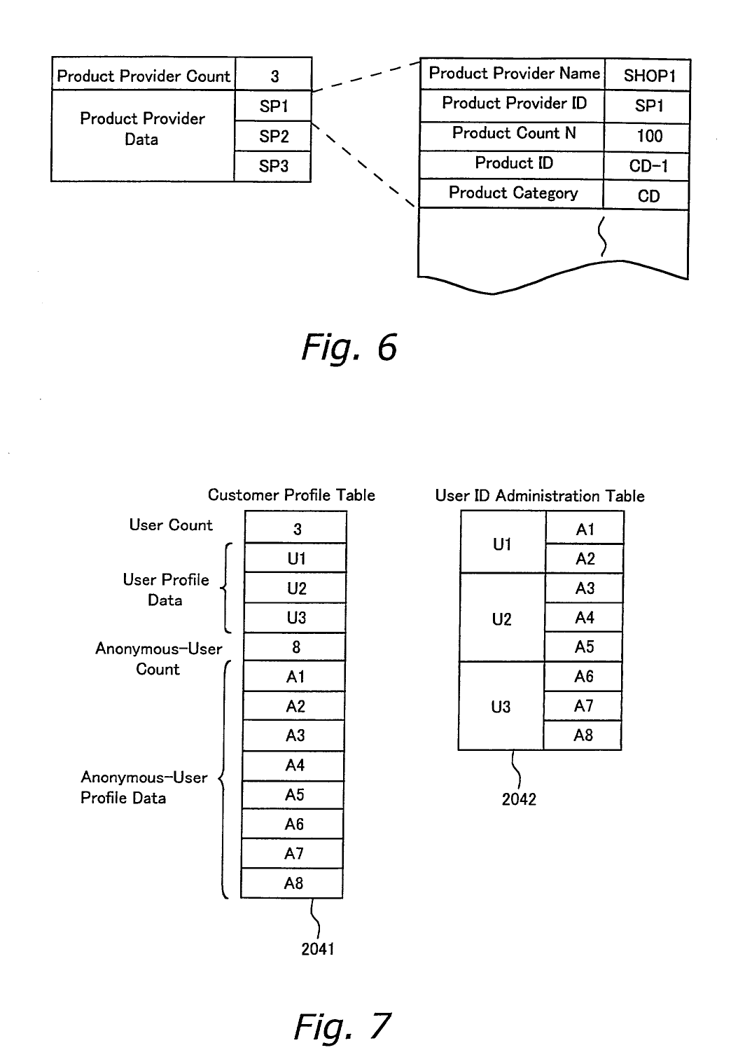

FIG. 6 is a conceptual explanatory diagram of information stored in the product provider DB 203. Number of product providers, and product provider data are stored in the product provider DB 203. The product provider data includes product provider name, product provider ID, number of products, product ID and product category. In this example, product provider SP1 provides 100 products, one among which is a CD specified by the product ID “CD-1.” Product provider name, product provider ID, product ID, and product category, which are stored in the product DB 201, are created based on the product provider DB 203.

FIG. 7 is a conceptual explanatory diagram of information stored in the customer DB 204. A customer profile table 2041 and a user ID administration table 2042 are stored in the customer DB 204. A count of users that the intermediary server 2 is using, profile data on each user, anonymous user count, and profile data on each anonymous user are recorded in the customer profile table 2041. User IDs and pseudonym IDs are stored, with correspondences assigned between them, in the user ID administration table 2042.

A user ID herein is information for identifying a user terminal on the present system. An “anonymous user” is a user who is specified by a pseudonym ID. A pseudonym ID is an ID that anonymizes and identifies a user specified by a user ID. A pseudonym ID is assigned a correspondence to any user ID whichever by means of the user ID administration table 2042. A single user ID may be assigned correspondences to a number of pseudonym IDs. Referring to the customer profile table in FIG. 7, the count of users that the intermediary server 2 is using is 3, and the number of anonymized anonymous users is 8. Referring also to the user ID administration table 2042, anonymous users A1 and A2 correspond to user U1; anonymous users A3-A5 correspond to user U2; and anonymous users A6-A8 correspond to user U3.

(2-2) User and Anonymous-User Profile Data

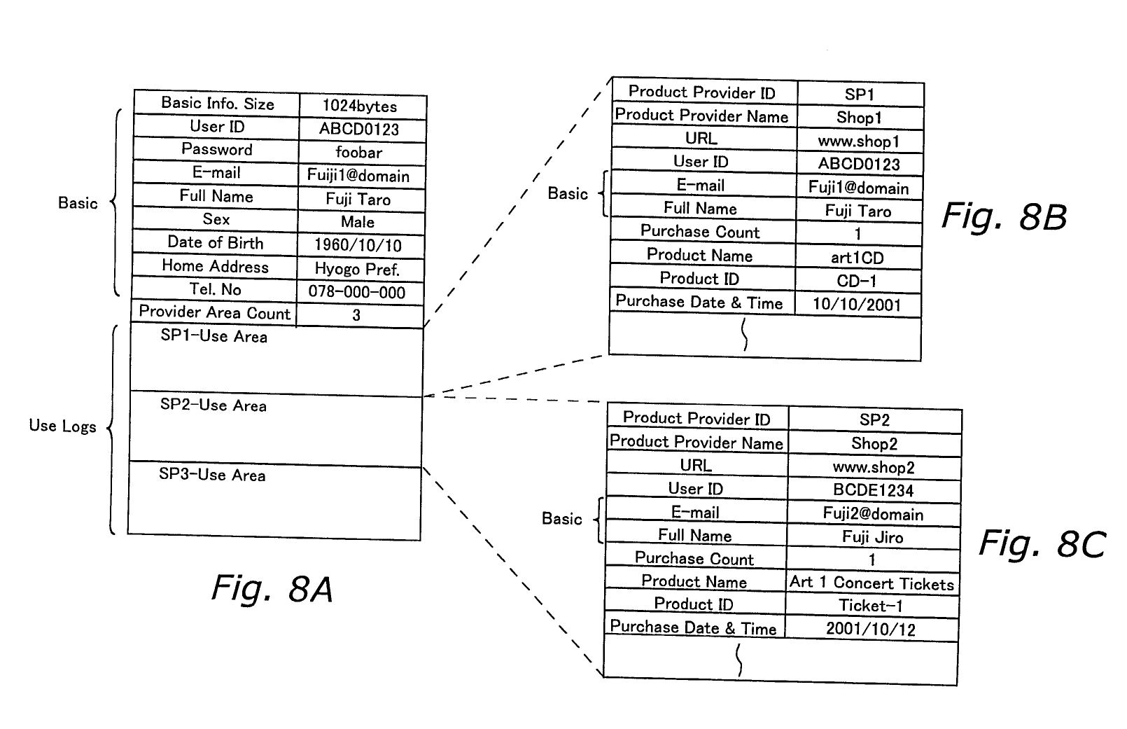

Next, using FIGS. 8-10, user profile data and anonymous-user profile data, which are stored in the customer DB 204, will be explained in detail.

First, user-profile data will be explained. The profile data on a user is the content of the user's shopping cart. FIGS. 8A-8C are explanatory diagrams illustrating the composition of the profile data for the users, which is stored in the customer profile table 2041. FIG. 8A indicates that the profile data contains basic information size, basic information, provider area count, and use log.

The basic information contains user ID, password, e-mail address, full name, sex, date of birth, home address, and phone number. The use log in this example is a log of user U1's use at electronic shops belonging to product providers SP1-SP3. A use log is recorded for each of the product providers. That is, product provider SP1's use log and product provider SP2's use log are recorded in an area for SP1, and in an area for SP2, respectively. The product providers, by means of the WWW browsers 51a-51c, may browse only those use logs that concern them. For example, the user U1 use log that is recorded in the area for SP1 can only be browsed by product provider SP1; while the user U1 use log that is recorded in the area for SP2 can only be browsed by product provider SP2.

FIG. 8B illustrates the composition of a use log. A user U1 use log that concerns product provider SP1 is exemplified herein. Use logs are information regarding products users have through their screens registered in a shopping cart, and products for which users have through their screens made a purchase instruction, in electronic shops the product providers run. Product provider ID, product provider name, and URL (Uniform Resource Locator) for designating an electronic shop are contained in the use logs. A use log also contains a user ID, a portion of the basic information, purchase count, product name, product ID, and purchase date and time. In the present example, user U1 has purchased a CD designated by product name “Art 1 CD,” and product ID “CD-1” on Oct. 10, 2001. A situation where purchase date and time are thus recorded indicates that a product has actually been purchased. A situation where the product name and product ID are recorded, but the purchase date and time are not recorded indicates a state in which a product has been registered in a shopping cart, but a purchase instruction has not yet been made.

FIG. 8C illustrates a use log for user U1 that concerns product provider SP2. In this example, user U1, in an electronic shop that product provider SP2 manages, has purchased a concert ticket designated by product name “Art 1 Concert Ticket” and product ID “Ticket-1,” on Oct. 12, 2001.

Next, profile data on anonymous users will be explained. “Anonymous-user profile data”—user profile data that corresponds to an anonymous user, in other words, shopping cart content—is created and saved independently. If there is a suggested product relevant to a product registered in a shopping cart, with registration of the product into the shopping cart being the event, anonymous-user profile data is created.

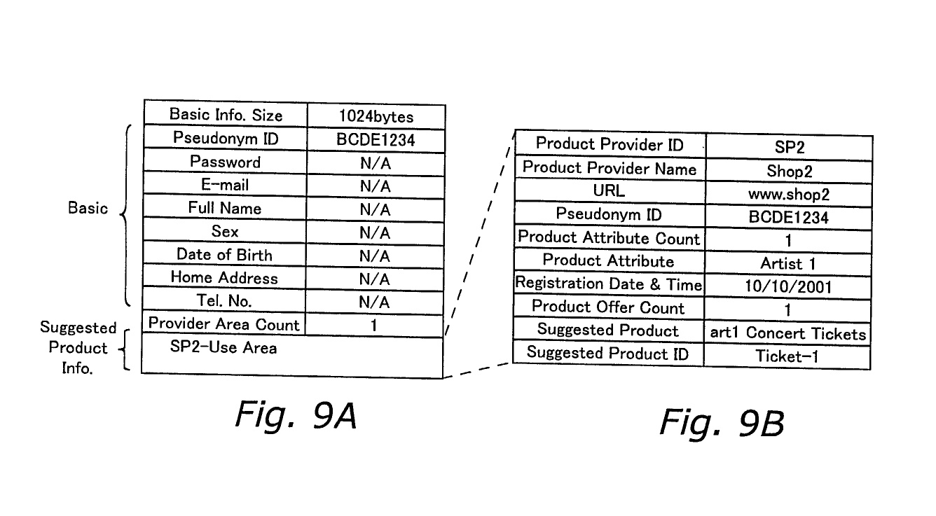

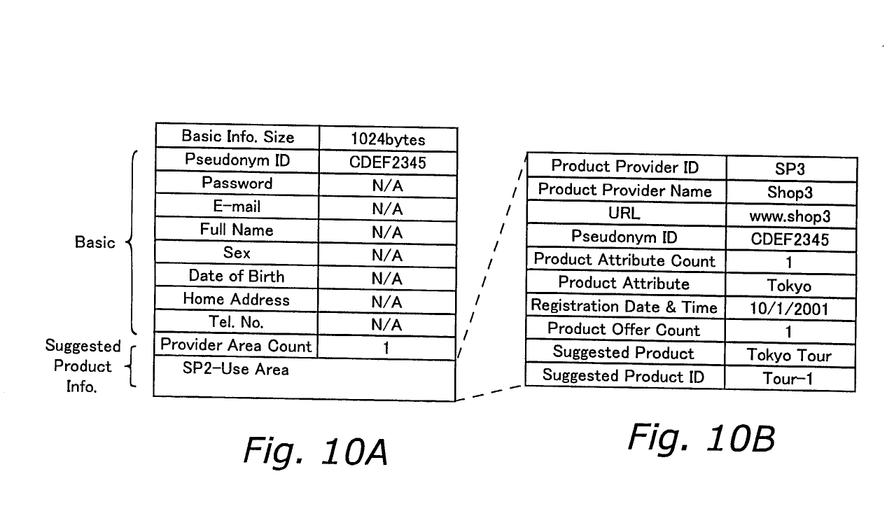

FIGS. 9A and 9B and FIG. 10 are explanatory diagrams illustrating the composition of profile data for the anonymous users in the customer profile table 2041. FIGS. 9A and 9B show profile data composition for anonymous user A1. In reference to the user ID administration table 2042, anonymous user A1 corresponds to user U1. Accordingly, anonymous user A1 is an anonymized user U1. The profile data for anonymous user A1 is prepared by user U1 registering in a shopping cart product “Art 1 CD,” for example, which falls under product category “CD.”

This anonymous userA1 profile data contains basic information size, basic information, provider area count, and information on product(s) for suggestion to anonymous user A1. The basic information contains pseudonym ID, password, e-mail address, full name, sex, date of birth, home address, and telephone number. The pseudonym ID is prepared by converting and anonymizing the user ID for user U1. Further, the basic information when recorded is anonymized to be undecipherable, so that user U1 cannot be designated from this data.

The suggested product information contains product provider ID, product provider name, and the URL for the product provider's electronic shop. Pseudonym ID, purchase count, product attribute count, product attributes, registration date and time, product offer count, suggested products, and suggested product IDs are also contained in the suggested product information. In this example, product “Art 1 Concert Ticket” that product provider SP2 provides is registered as a suggested product with respect to anonymous user A1 designated by pseudonym ID “BCDE1234.” The suggested product and product “Art 1 CD” are deemed to be mutually correlated because product attribute “artist name” that they have in common is together “artist 1.” User terminal 4a that user U1 operates may acquire suggested product information for anonymous user A1, even if the suggested product is not registered in the shopping cart. Nevertheless, the product providers 5a-5c may not acquire suggested product information that another product provider provides. In this example, product provider SP2 may through WWW browser 51b acquire suggested product information for anonymous user A1, but product providers SP1, SP3 may not acquire suggested product information for anonymous user A2.

FIG. 10 is an example of profile data for anonymous user A2. Referring to user ID administration table 2042, anonymous user A2 also corresponds to user U1. Accordingly, anonymous user A2 is an anonymized user U1. Profile data for anonymous user A2 is created when the foregoing suggested product “Art 1 Concert Ticket” is registered in the shopping cart. This anonymous user A2 profile data contains the same subject matter as the profile data for anonymous user A1. In this example, a suggested product “Tokyo Tour” that product provider SP3 provides is registered as a suggested product for anonymous user A2, who is designated by pseudonym ID “CDEF2345.” The suggested product and product “Art 1 Concert Ticket” are deemed to be mutually correlated because product attribute “city/region name” that they have in common is together “Tokyo.” Only product provider SP3 is able to acquire the suggested product information for anonymous user A2.

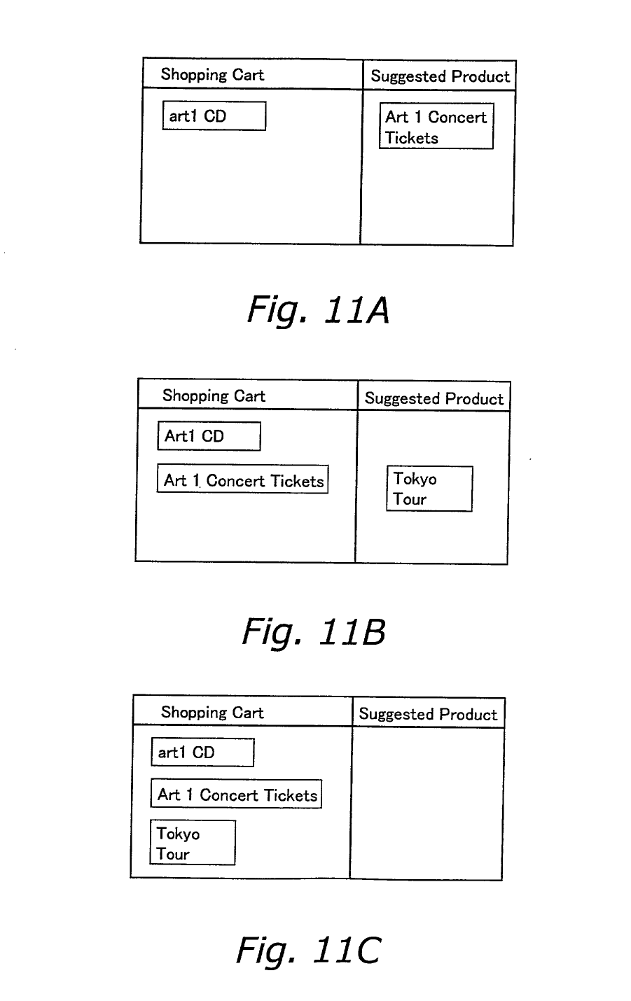

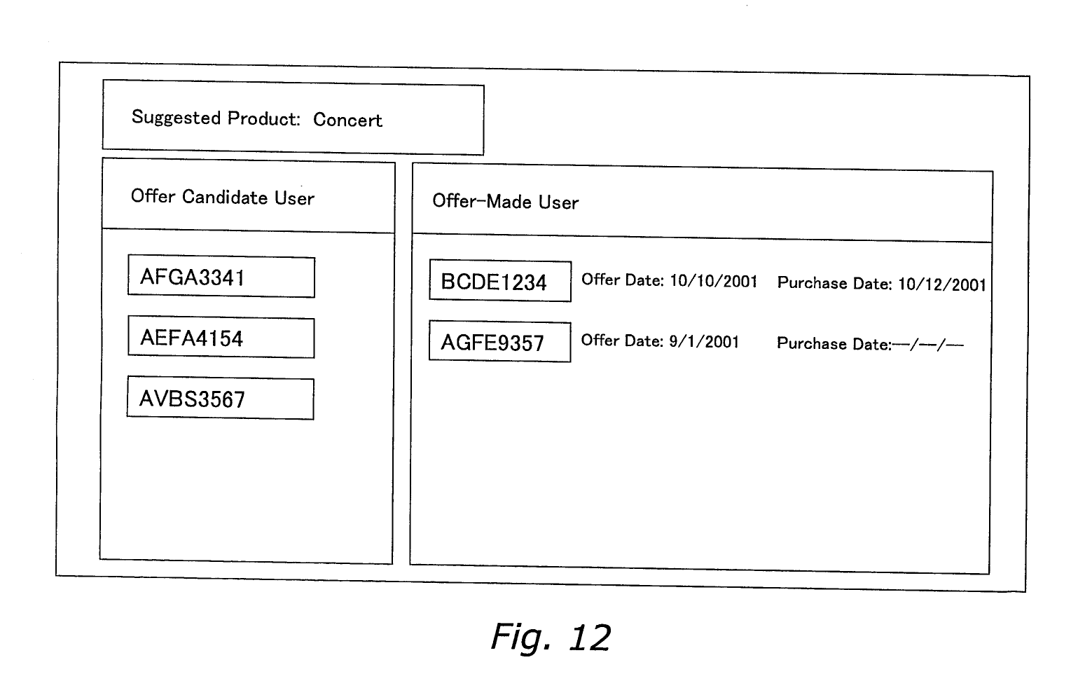

FIGS. 11A-11C and FIG. 12 are display examples of user profile data and anonymous user profile data. FIGS. 11A-11C and FIG. 12 show respectively display examples on user terminals and display examples on product provider terminals. FIG. 11A is a display example of profile data for user U1 and profile data for anonymous user A1, set out by user terminal 4a. In the figure, the product name displayed in the shopping cart is the product name recorded in the profile data for user U1 (see FIG. 8B). The product name that is displayed as a suggested product is the product name displayed in the profile data for anonymous user A1, who corresponds to user U1 (see FIG. 9B). At this stage, because profile data has not been created for anonymous user A2, “Tokyo Tour” is not displayed as a suggested product. User U1 may register suggested product “Art 1 Concert Ticket” by dragging and dropping it into the shopping cart.

FIG. 11B is a separate display example of profile data for user U1 and profile data for anonymous user A2, set out by user terminal 4a. This figure shows the situation in which suggested product “Tokyo Tour,” which correlates to “Art 1 Concert Ticket,” is being suggested after user U1 has registered suggested product “Art1 Concert Ticket” in the shopping cart. At this stage, the profile data for anonymous user A2, which aforementioned FIG. 10 shows, is created. FIG. 11C is an example of a screen set out by user terminal 4a, for the situation in which user U1 has registered suggested product “Tokyo Tour” in the shopping cart. This situation illustrates the profile data for user U1, shown in aforementioned FIGS. 8A-8C, having been created. Here in FIGS. 8A-8C the supposition is that data relating to “Tokyo Tour” is described in an area for SP3.

FIG. 12 is a display example of user profile data and anonymous-user profile data that are displayed on product provider terminals 5a-5c. An example of a screen on product provider terminal 5b for product provider SP2, who provides the concert tickets, is shown herein. The user to whom concert tickets have been offered is displayed as an “offer-made user” on the screen. Further, a user scheduled for a concert-ticket offer is displayed as an “offer candidate user.”

To illustrate, pseudonym ID “BCDE1234” for anonymous user A1 is displayed as one of “_offer-made users._” This anonymous user A1, after registering suggested concert ticket “Art 1 Concert Ticket” in the shopping cart (see FIGS. 11A-11C) has purchased this product (see FIG. 8C). “Registration date and time” within the profile data for anonymous user A1 is displayed as “Offer Date.” “Purchase date and time” for product name “Art 1 Concert Ticket” within the user U1 profile data corresponding to anonymous user A1 is displayed as “Purchase Date.”

(2-3) Intermediary Server 2 Program Functions

To continue, principal functions of programs that the intermediary server 2 includes will be explained with reference once more to FIG. 3. As set out in FIG. 3, the WWW server 205 is connected via the network 1 to product provider servers 3a-3c, user terminals 4a-4c, and product provider terminals 5a-5c. The WWW server 205 provides to user terminals 4a-4c Web pages for electronic shops that make the product providers' products available. The WWW server 205 also provides to user terminals 4a-4c Web pages that display shopping carts. When users have registered a product in a shopping cart, the WWW server 205, utilizing JavaScript™ or the like, acquires the user ID and product ID from the user terminals 4a-4c. Furthermore, the WWW server 205 provides display screens for the suggested products exemplified in aforementioned FIGS. 11A-11C and FIG. 12 to user terminals 4a-4c and product provider terminals 5a-5c, respectively.

Via WWW server 205 the customer alteration module 206 acquires user profile data from the user terminals 4a-4c and writes it into the customer DB 204. Further, the customer alteration module 206 creates, and writes into the customer DB 204, anonymous-user profile data and user ID administration table 2042.

The offer module 207 acquires pseudonym IDs from the anonymizer module 208, and suggested-product product attributes and product provider IDs from the attribute-converting module 209, and sends anonymous-user profile data to the customer alteration module 206.

The anonymizer module 208 converts user IDs into pseudonym IDs, and sends the pseudonym IDs to the offer module. Preparation of a pseudonym ID is carried out utilizing an anonymizing function Fa (user ID), wherein the user ID is the independent variable, to compute a fresh pseudonym ID not present in the intermediary server 2. In the example of FIGS. 8A-8C and FIGS. 9A and 9B, user ID “ABCD0123” for user U1 is converted into pseudonym ID “BCDE1234” for anonymous user A1 by Fa (ABCD0123)-BCDE1234.

The attribute-converting module 209 converts product names and product IDs registered in shopping carts into suggested product names, suggested product IDs and product attributes. This conversion is made, for example, by retrieving, from the attribute table 2022 noted earlier, product attributes that product categories for products registered in the shopping cart have in common with other product categories. In aforementioned FIGS. 8A-8C and FIGS. 9A and 9B, product “Art 1 CD” in product category “CD” for product provider SP1 has product attribute “artist name” in common with product category “concert tickets” (see FIG. 5). Accordingly, product “Art 1 CD” is converted into that artist name “Artist 1.”

The provider-administrating module 210 writes data into, and changes data in, the product provider DB 203. In addition, if from the product provider terminals 5a-5c there is a browse request for the customer DB 204, the provider-administrating module 210 reads out data that the requester product-provider terminal can browse. Furthermore, the provider-administrating module 210 accepts product-attribute add/delete requests from the product provider terminals 5a-5c for products they deal in.

In accordance with product-attribute add/delete requests from the product provider terminals 5a-5c, the attribute-changing module 211 updates the attribute table 2022 in the product attribute DB 202. For example,

In FIG. 5 for example, if product attribute “artist name” for concert tickets is deleted, CD and Concert Tickets no longer correlate with one another. Conversely, adding product attribute “artist name” to Package Tour would have CD and Package Tour correlating mutually.

The offer-displaying module 212 reads out suggested product information from the anonymous-user profile data recorded in the customer DB 204, and provides it to the user terminals 4a-4c and the product provider terminals 5a-5c, via the WWW server 205

(3) Process Flow

Next the flow of routines that intermediary server 2 carries out will be specifically explained. The intermediary server 2 chiefly performs a suggested-product information-preparation routine, a cart-updating routine, and a housekeeping routine.

(3-1) Suggested-Product Information-Preparation Routine

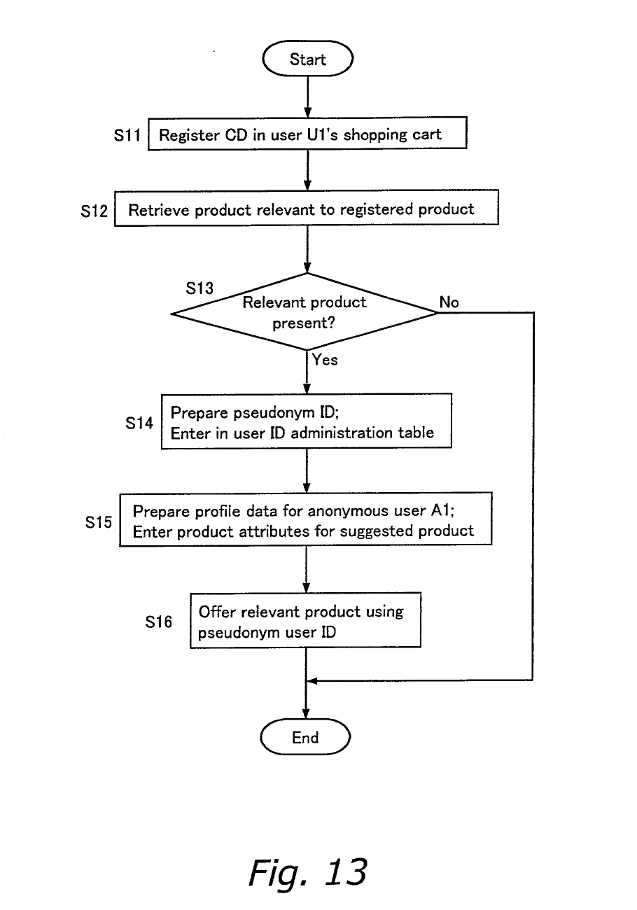

FIG. 13 is a flowchart illustrating flow of the suggested-product information-preparation routine. Herein, an instance in which user U1 has registered product provider SP1's product “Art 1 CD” in a shopping cart, and an instance in which product “Art 1 Concert Tickets” are offered to user terminal 4a will be explained.

Step S11: The WWW server 205 provides a Web page displaying shopping-cart content to user terminal 4a. When user U1 registers product “Art 1 CD” in the shopping cart, using JavaScript™ or the like, the WWW server 205 acquires user ID “ABCD0123” for user terminal 4a, product name “Art 1 CD,” product ID “CD-1,” and product provider ID “SPl.” Subsequently, the WWW server 205 sends the acquired information to the customer alteration module 206. The customer alteration module 206 sends this data to the offer module 207. In addition, the customer alteration module 206 updates the profile data for user U1. Specifically, if there is no area for product provider SP1, one is prepared, into which the use log is written. If there already is an area serving product provider SP1, the product name and product ID are added to the use log.

Step S12: The offer module 207 respectively sends user U1's user ID to the anonymizer module 208, and product name “Art 1 CD” to the attribute-converting module 209. The attribute-converting module 209 consults the attribute table 2022 in the product attribute DB 202, and searches for a product category that has a product attribute in common with either product attribute “CD title, artist name” in the product category “CD” belonging to product name “Art 1 CD.” If the search results in there being no appropriate product category, the present routine ends. In this example, because product category “concert tickets” has it that product attribute “artist name” is in common with product category “CD,” step S14 ensues.

Step S14: The anonymizer module 208 converts user U1's user ID “ABCD0123” into anonymous user A1's pseudonym ID “BCDE1234.” The anonymizer module 208 sends pseudonym ID “BCDE1234” to the customer alteration module 206 via the offer module 207. In the user ID administration table 2042, the customer alteration module 206 enters anonymous user A1's pseudonym ID “BCDE1234,” assigning it a correspondence to user U1's user ID “ABCD0123.”

Step S15: The attribute-converting module 209, with the value “Artist 1” as the “artist name” for product “Art 1 CD” as a key, retrieves product category “concert tickets” in product DB 201. In this example, product name “Art 1 Concert Ticket,” product ID “Ticket-1,” and product provider ID “SP2” are obtained as the search results. The attribute-converting module 209 transmits product provider name “SHOP 2,” product provider ID “SP2,” product attribute value “Artist 1,” product name “Art 1 Concert Ticket,” and product ID “Ticket-1” to the customer alteration module 206 via the offer module 207.

Here, should the intermediary server 2 not have the product DB 201, the attribute converting module 209 transmits concert-ticket attribute value “Artist 1 ” to the offer module 207, together with the product provider name “SHOP 2” and product provider ID “SP2,” without searching for suggested products in the product DB 201.

Based on anonymous user A1's pseudonym ID “BCDE1234,” product provider name “SHOP 2,” product provider ID “SP2,” product attribute value “Artist 1,” product name “Art 1 Concert Ticket,” and product ID “Ticket-1,” the customer alteration module 206 creates the profile data illustrated in FIGS. 9A and 9B for anonymous user A1. The customer alteration module 206 writes the created profile data into the customer DB 204.

Step S16: The offer-displaying module 212, via the WWW server 205, provides the suggested product information contained in anonymous user A1's profile data to the user terminal 4a, which user U1 operates. For instance, on a Web page displaying a shopping cart, the offer-displaying module 212 prepares the suggested-product display area illustrated in FIGS. 11A-11C, and here writes in the suggested product. Suggested product “Art 1 Concert Ticket,” as shown in FIG. 11A, is thereby displayed on user terminal 4a. Moreover, anonymous user A1 is displayed as an offer-made user on concert-ticket product provider SP2's product provider terminal 5b (see FIG. 12).

Here, if in step S11 user U1 has registered suggested product “Art 1 Concert Ticket” in the shopping cart, the intermediary server 2 repeats steps S12-S17, and offers a relevant product to user U1 over again. In this example, product category “package tour” has, in the attribute table 2022 in the product attribute DB 202, product attribute “city/region” in common with product category “concert tickets.” The intermediary server 2 searches in the product DB 201 for the package tour whose value for product attribute “city/region” is “Tokyo,” and proffers “Tokyo Tour.” In concrete terms, the intermediary server 2 prepares profile data for anonymous user A2, who is designated with the pseudonym ID “CDEF2345” that is illustrated in FIG. 10. The screen illustrated in FIG. 11B is displayed on user terminal 4a. On this screen, product “Art 1 Concert Ticket” is registered in the shopping cart, and product “Tokyo Tour” is being displayed as a suggested product.

(3-2) Cart-Updating Routine

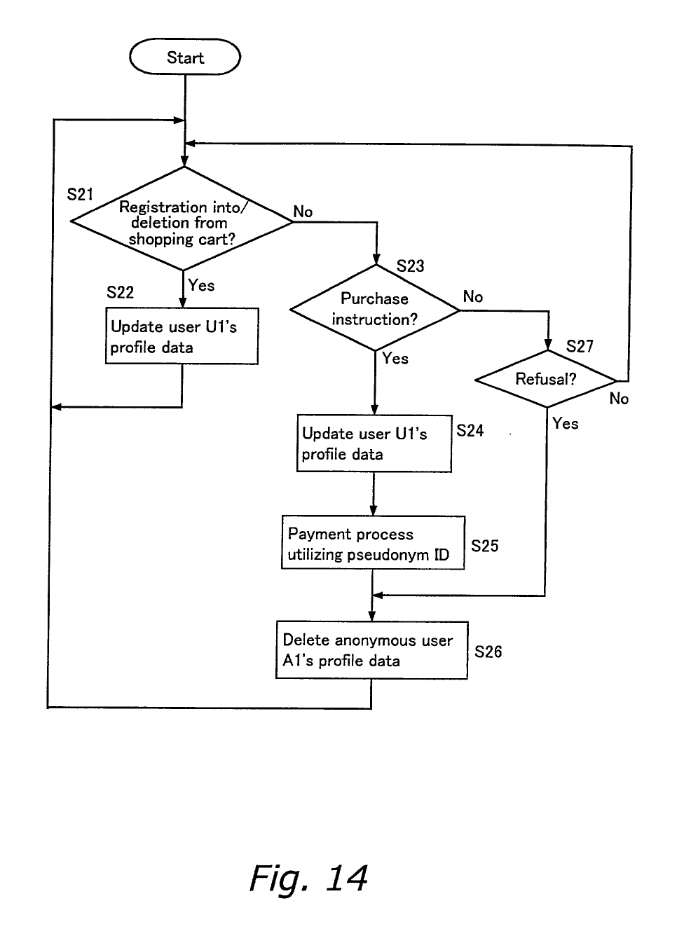

FIG. 14 is a flowchart illustrating flow of the cart-updating routine that the intermediary server 2 carries out. Supposing that product “Art 1 CD” is registered in the shopping cart displayed on user terminal 4a, and that product “Art 1 Concert Ticket” is being displayed as a suggested product will facilitate explanation. Likewise, that a Web page for product provider SP1's electronic shop SHOP 1 is being displayed on user terminal 4a is supposed. Starting up the intermediary server 2 launches the following routine.

Step S21: The WWW server 205 judges whether or not the product(s) in the shopping cart have changed. Specifically, it decides whether an instruction to register in the shopping cart suggested product “Art 1 Concert Ticket,” an instruction to register in the shopping cart any of the products provided at SHOP 1, or an instruction to delete all at once the product(s) registered in the shopping cart, has been received from the user terminal 4a. If it decides “Yes,” step S22 ensues; if it decides “No,” step S23 ensues.

Step 22: By means of CGI or the like the WWW server 205 reflects in user U1's profile data in the customer DB 204 the change in content of the product(s) in the shopping cart. If for example registering suggested product “Art 1 Concert Ticket” in the shopping cart has been instructed, the customer alteration module 206 prepares a use log relating to product “Art 1 Concert Ticket.” Anonymous user A1's pseudonym ID is described in the use log. Product “Art 1 Concert Ticket” is thereby registered in user U1's shopping cart as illustrated in FIG. 11B.

On the other hand, if deletion of a product, e.g., “Art 1 CD” within the shopping cart has been instructed, the customer alteration module 206 deletes the use log relating to “Art 1 CD” from user U1's profile data. After a suggested product has been registered in a shopping cart, if that product is to be deleted from the shopping cart, the same routine is carried out.

Step S23: The WWW server 205 judges whether or not an instruction to purchase a product in the shopping cart, e.g., product “Art 1 Concert Ticket,” has received from the user terminal 4a. If it decides “Yes,” step S24 ensues; if it decides “No,” later described step S27 ensues.

Step S24: The customer alteration module 206 writes the purchase date and time and the purchase count into the use log relating to product “Art 1 Concert Ticket” that is contained in user U1's profile data.

Step S25: Using anonymous user A1's pseudonym ID “BCDE1234,” the customer alteration module 206 carries out a settlement process for purchasing the product “Art 1 Concert Ticket.” Routinely utilized encryption technology such as SSL or credit card payment procedure, or payment methods other than these may be used for the payment process.

Step S26: The customer alteration module 206 deletes anonymous user A1's profile data, in which the purchasing-source suggested product “Art 1 Concert Ticket” is described in the suggested product information, from the customer DB 204. Likewise, the customer alteration module 206 deletes anonymous user A1's pseudonym ID from the user ID administration table 2042. The routine thereafter returns to step S21. Deletion of the user profile and pseudonym ID for an anonymous user may be carried out if a suggested product, other than when it has been purchased, has not been registered in a shopping cart though a fixed time interval has elapsed since its offer. Details in this regard will be described with the housekeeping routine next.

Step S27: The WWW server 205 judges whether or not a refusal of the suggested product “Art 1 Concert Ticket” has been received from the user terminal 4a. “Refusal” means, for example, the suggested product being moved by dragging and dropping it outside the shopping cart and the suggested product display area. In this case, aforementioned step S26 ensues, where deletion of profile data relating to the refused suggested product, and deletion of the pseudonym ID, are carried out. If there is no change to a product within the shopping cart, no purchase instruction, or no refusal of a suggested product, the process flow returns to step S21 once more, and the routine just described is repeated.

Although herein an instance in which the suggested product is “Art 1 Concert Ticket” was described, if the intermediary server 2 were to receive an instruction from the user terminal 4a to register, e.g., suggested product “Tokyo Tour” in the shopping cart, the same routine would be carried out. The customer alteration module 206 would prepare a use log relating to product “Tokyo Tour” in user U1's profile data. A screen example for this situation is FIG. 11C, in which “Tokyo Tour” is registered in the shopping cart.

(3-3) Housekeeping Routine

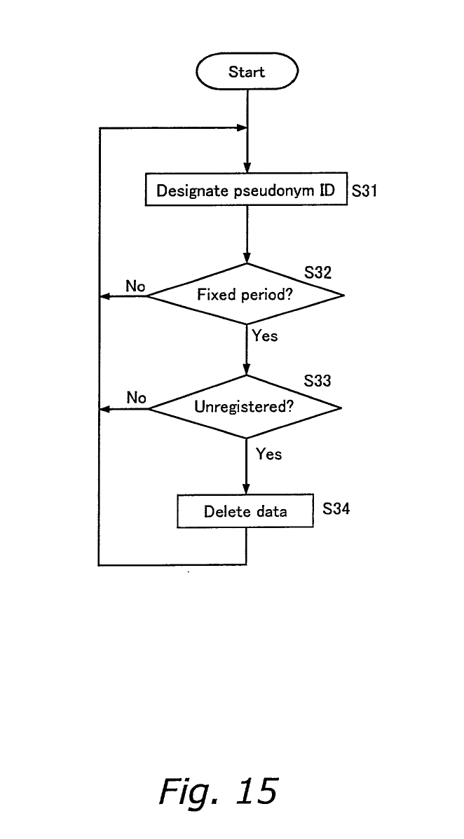

FIG. 15 is a flowchart illustrating flow of the housekeeping routine that the intermediary server 2 carries out. When the intermediary server 2 is started up, the following routine begins.

Step S31: The customer alteration module 206 designates as a target ID any pseudonym ID in the customer-DB 204 user ID administration table 2042. The target ID initially might be anonymous user A1 for example.

Step S32: The customer alteration module 206 judges from the registration date and time contained in the profile data for the target ID whether or not a fixed time interval has elapsed since a product was suggested to anonymous user A1. If the fixed time interval has elapsed, step S33 ensues. If the fixed time interval has not elapsed, the routine returns to step S31, where a different pseudonym ID is taken to be the target ID.

Step S33: The customer alteration module 206 consults the use log for user U1's profile data in the customer DB 204, and judges whether or not the product suggested to anonymous user A1 has been registered in the shopping cart. If it has not been registered, step S34 ensues. If it has been registered, the routine returns to step S31 where a different pseudonym ID is taken to be the target ID.

Step S34: The customer alteration module 206 deletes the target ID, e.g., pseudonym ID “BCDE1234,” from the user ID administration table in the customer DB 204. Likewise, the customer alteration module 206 deletes anonymous user A1's profile data from the customer DB 204. The process flow thereafter returns to step S31, and by repeating the just-described routine on a different pseudonym ID, and offer of a product in which the user does not possess interest though a long interval of time has elapsed since the offer is suspended.

By the foregoing routines, information relevant to the product “Art 1 CD” that user U1 registered in the shopping cart may be provided to product provider SP2 while preserving user U1's privacy. In this case, the product name “Art 1 CD” of the product that user U1 registered in the shopping cart is converted into the attribute “Artist 1” and provided to product provider SP2. Accordingly, as far as user U1 is concerned, the product provider SP2 does without being directly informed of the product “Art 1 CD” registered in the shopping cart. Likewise, as far as the product provider SP2 is concerned, only that information necessary in offering its product “Art 1 Concert Ticket” can be gathered.

Furthermore, in case user U1 also registers suggested product “Art 1 Concert Ticket” in the shopping cart, the settlement process is carried out according to a pseudonym ID, and therefore user U1 can purchase the suggested product while his or her anonymity is preserved.

Other Embodied Examples

(A) Other Methods of Anonymizing Information

Utilizing meta-function Mf (user ID, product name, product provider provider-destination product provider ID, Cinfo) may have it that not only pseudonym ID and product attributes for suggested products, but also basic user information, are converted. Herein, Cinfo is control information, the value of which sets a disclosure level; and basic user information is made public according to the disclosure level.

Although in the foregoing first embodied example user IDs among the basic information are converted into pseudonym IDs, basic information apart from user IDs (password, e-mail address, full name, sex, date of birth, home address, telephone number) is recorded undecipherably to the product-information provider for whom it is destined. In the present embodied example, by means of meta-function Mf, part or all of this data is written decipherably into the profile data for anonymous users.

In concrete terms, control information Cinfo settings are accepted for each of the product providers from the user terminals 4a-4c, and entered in the customer DB 204. The value of control information Cinfo has it that a number of settings can be made, in such cases as where only the full name is known, where only the sex is known, where only the age bracket is known, and where only the residential area is known. In aforementioned step S15 in which the customer alteration module 206 prepares anonymous user A1's profile data, based on control information Cinfo basic information for anonymous user A1 is prepared. For instance, according to the control information Cinfo value, full name, sex, age bracket, residential area, etc. are entered in the profile data for the anonymous users.

Utilizing this method, users set the control information Cinfo value, which while therefore protecting users' privacy, makes it so that product providers can share basic information useful in marketing.

(B) Although only suggested product “Art 1 Concert Ticket” relevant to product “Art 1 CD” is offered to user U1 in step S16 in the foregoing embodied example, it may have product provider SP2 able further to add a suggested product. That is, WWW server 205 may accept from product provider SP2's product-provider terminal 5b a change in suggested product. The customer alteration module 206 adds suggested product information further relevant to the suggested product information for suggested product “Art 1 Concert Ticket” in anonymous user A1's profile data. According to its own judgment, product provider SP2 can in this case add a suggested product, which therefore serves further in marketing. (C) Although in step S15 only product provider SP2 deals in suggested product “Art 1 Concert Ticket” relevant to product “Art 1 CD” in the foregoing embodied example, it may have all the product providers able to offer suggested products wherein there is a plurality of product providers that deal in suggested products, and may have designated product provider(s) suggest product(s).

If all the product providers are allowed to offer suggested products, in step S15 suggested product information with respect to all the product providers is prepared in anonymous user A1's profile data. In this case, a user who has received an offer may by comparing prices decide from whichever of the product providers he or she will make a purchase.

On the other hand, if a designated product provider is allowed to offer a product(s), priority-ranking settings for the product providers are accepted in advance from user U1, for example, to let the product provider whose priority ranking is highest offer a product(s). Specifically, priority rankings for the product providers are entered according to settings from user U1 into user U1's profile data in the customer DB 204. Then in step S15, in a situation where a plurality of product providers is handling suggested product “Art 1 Concert Ticket,” suggested product information is prepared in anonymous user A1's profile data only for the highest-ranking product provider. In this case a user may preferentially receive product offers from his or her favorite product provider.

(D) Programs that execute the foregoing inventive methods, and computer-readable recording media on which the programs are recorded, are included in the present invention. As recording media in this respect, flexible disks, hard disks, semiconductor memory, CD-ROMs, DVDs, magneto-optical disks (MOs) and others that a computer can read may be cited.

Utilizing the present invention shares user use logs among product providers while protecting the users' privacy, which serves to promote product sales. Moreover, utilizing the present invention enables, by the product providers sharing users' use logs to extend their services into one another's areas, what had been troublesome: the provision of diverse products by each product provider on its own.

Only selected embodiments have been chosen to illustrate the present invention. To those skilled in the art, however, it will be apparent from the foregoing disclosure that various changes and modifications can be made herein without departing from the scope of the invention as defined in the appended claims. Furthermore, the foregoing description of the embodiments according to the present invention is provided for illustration only, and not for limiting the invention as defined by the appended claims and their equivalents.

What is claimed is:

1. A marketing method for promoting to users on a network sales of product groups including a first product group that a first provider provides and a second product group that a second provider provides, the marketing method including:
a product-storage step of storing product information including first product information relating to the first products included in the first product group, and second product information relating to the second products included in the second product group;
a product-selection acceptance step of accepting selection of a product in which a user takes an interest;
an intention storage step if the user has selected any first product, of assigning a correspondence between and storing the first product information relating to said first product, and a first user identifier by which the first provider identifies the user;
a product reworking step, based on the first product information relating to said first product and the second product information, of reworking the first product information relating to said first product, into second product information relating to any second product having relevancy to said first product; and
a first provision step of providing the second product information on said second product, obtained in said product reworking step, to the user identified with the first user identifier.

2. The marketing method set forth in claim 1, further including a second provision step of providing to the second provider the second product information obtained in said product reworking step, and the first user identifier.

3. The marketing method set forth in claim 2, further including:
a first user-reworking step of reworking the first user identifier into a second user identifier by which the second provider identifies the user; wherein
said second provision step provides the second user identifier to the second provider instead of the first user identifier.

4. The marketing method set forth in claim 3, wherein said intention storing step, if the user has selected said second product based on the second product information provided in said first provision step, assigns a correspondence between and further stores second product information relating to said second product, and the second user identifier.

5. The marketing method set forth in claim 3, further including:
a purchase acceptance step of accepting from the user, based on the first user identifier, an instruction to purchase said second product, originating from the second product information provided in said first provision step; and
a settlement process step of carrying out a payment process for said second product, utilizing the second user identifier corresponding to the first user identifier.

6. The marketing method set forth in claim 5, wherein:
the product groups further include a third product group that a third provider provides;
said product-storage step further stores third product information relating to the third products included in the third product group; and
if in said purchase acceptance step an instruction to purchase said second product has been accepted, said product reworking step, based on the second product information relating to said second product and the third product information, reworks the second product information relating to said second product, into third product information relating to any third product having relevancy to said second product.

7. The marketing method set forth in claim 6, further including a third provision step of providing to the third provider the third product information obtained in said product reworking step, and the first user identifier.

8. The marketing method set forth in claim 6, further including a second user-reworking step of reworking the first user identifier into a third user identifier by which the third provider identifies the user; wherein
said third provision step provides the third user identifier to the third provider instead of the first user identifier.

9. The marketing method set forth in claim 2, further including an alteration step of accepting, according to a request from the second provider, a change in the second product information provided to the user in said first provision step.

10. The marketing method set forth in claim 1, further including:
a request-acceptance step of accepting a request for provision of the first product information stored, in an assigned correspondence with said first user identifier, in said intention-storage step;
an iterative execution step of iteratively executing said first provision step whenever there is a said request; and
a termination step of ending said iterative execution step.

11. The marketing method set forth in claim 2, further including a provider-selection acceptance step of accepting from the user selection of a provider in which the user takes an interest; wherein
in said product reworking step, first product information relating to said first product is reworked into second product information for second products that the selected provider handles among any second products having relevancy to said first product.

12. The marketing method set forth in claim 2, wherein:
said intention storage step further stores, in correlation with the first product information and the first user identifier, user information relating to the user; and
said second provision step further provides the user information to the second provider.

13. The marketing method set forth in claim 12, further including:
a disclosure-level setting step of setting a disclosure level at which the user information is provided to the second provider in said second provision step; and
a user information reworking step of reworking according to the disclosure level the user information provided to the second provider.

14. A marketing method for promoting on a network sales of product groups including a first product group that a first provider provides and a second product group that a second provider provides, the marketing method including:
a product-storage step of storing product information including first product information relating to the first products included in the first product group, and second product information relating to the second products included in the second product group;
a product-selection acceptance step of accepting selection of a product in which a user takes an interest;
an intention storage step if the user has selected any first product, of assigning a correspondence between and storing the first product information relating to the selected first product, and a first user identifier identifying the user;
a first user-reworking step of reworking the first user identifier into a second user identifier by which the second provider identifies the user; and
a second provision step of providing to the second provider the first product information relating to said first product, and the second user identifier.

15. A marketing device for promoting on a network sales of product groups including a first product group that a first provider provides and a second product group that a second provider provides, the marketing device including:
product storage means for storing product information including first product information relating to the first products included in the first product group, and second product information relating to the second products included in the second product group;
product-selection acceptance means for accepting selection of a product in which a user takes an interest;
intention storage means for, if the user has selected any first product, assigning a correspondence between and storing the first product information relating to the selected first product, and a first user identifier identifying the user;
product reworking means, based on the first product information relating to said first product and the second product information, for reworking the first product information relating to said first product, into second product information relating to any second product having relevancy to said first product; and
first provision means for providing the second product information, obtained by said product reworking means, to the user identified with the first user identifier.

16. A computer product for making a computer function as a marketing device for promoting on a network sales of product groups including a first product group that a first provider provides and a second product group that a second provider provides, the computer product for making the computer function as:
product storage means for storing product information including first product information relating to the first products included in the first product group, and second product information relating to the second products included in the second product group;
product-selection acceptance means for accepting selection of a product in which a user takes an interest;
intention storage means for, if the user has selected any first product, assigning a correspondence between and storing the first product information relating to the selected first product, and a first user identifier identifying the user;
product reworking means, based on the first product information relating to said first product and the second product information, for reworking the first product information relating to said first product, into that second product information which relates to any second product having relevancy to said first product; and
first provision means for providing the second product information, obtained by said product reworking means, to the user identified with the first user identifier.

17. A computer-readable recording medium on which is recorded a marketing program for promoting to users on a network sales of product groups including a first product group that a first provider provides and a second product group that a second provider provides, the computer-readable recording medium on which is recorded a marketing program for executing:
a product-storage step of storing product information including first product information relating to the first products included in the first product group, and second product information relating to the second products included in the second product group;
a product-selection acceptance step of accepting selection of a product in which a user takes an interest;
an intention storage step if the user has selected any first product, of assigning a correspondence between and storing the first product information relating to said first product, and a first user identifier by which the first provider identifies the user;
a product reworking step, based on the first product information relating to said first product and the second product information, of reworking the first product information relating to said first product, into second product information relating to any second product having relevancy to said first product; and
a first provision step of providing the second product information on said second product, obtained in said product reworking step, to the user identified with the first user identifier.
As recording media herein, flexible disks, hard disks, semiconductor memory, CD-ROMs, DVDs, magneto-optical disks (MOs) and others that a computer can read may be cited.

18. A user-operated computer comprising:
a network-connection means for communicatively connecting the computer to a network, wherein
the computer is connected to the marketing device set forth in claim 15 for promoting on a network sales of a product group including first products that a first provider provides and second products that a second provider provides;
a receiving means for receiving from the marketing device second product information relating to second products relevant to first products in which the user takes an interest; and
offering means for outputting, as information relating to suggested products, the second product information received from said receiving means.
The present invention is applicable to computers that the users aforementioned in the first invention operate.

19. For promoting on a network sales of a product group including first products that a first provider provides and second products that a second provider provides, an information acquisition device that the second provider uses, comprising:
a network-connection means for communicatively connecting the information acquisition device to a network, wherein
the information acquisition device is connected to a computer for executing the marketing method set forth in claim 2;
an acquisition means for acquiring from the computer a first-user identifier for designating a first user taking an interest in a said first product, and second product information relating to a said second product having relevancy to the said first product; and
output means for outputting the first-user identifier that said acquisition means has acquired, and the second product information.
